(19) United States
(12) Patent Application Publication
(10) Pub. No.: US 2026/0295881 A1
(43) Pub. Date: Oct. 1, 2026

(54) CUTTING GUIDE HAVING A PROTRUDING SEAM LOCKING FEATURE

(71) Applicant: Alpine Trails Studio LLC, Draper, UT (US)

(72) Inventor: Jared Jackson, Draper, UT (US)

(21) Appl. No.: 19/095,358

(22) Filed: Mar. 31, 2025

(51) Int. Cl. B26B 29/06

(52) U.S. Cl. CPC B26B 29/06

(57) ABSTRACT

A cutting guide may have a protruding seam locking feature (or features) to facilitate the consistent cutting of a material with a desired shape or pattern. A seam locking feature protrudes from a bottom surface of the cutting guide to form a locking edge against which a seam can be aligned while the material is cut. A seam locking feature may be formed of a non-slip material to restrict movement of the cutting guide during cutting. A seam locking feature (or features) may have a variety of shapes or configurations to facilitate the cutting of material with a corresponding variety of shapes or patterns.

### CROSS-REFERENCE TO RELATED APPLICATIONS

N/A

### BACKGROUND

A cutting guide is a tool for cutting fabric or other materials (hereafter generally “materials”). Users, such as quilters, typically use a cutting guide to consistently cut materials with a desired shape and dimensions.

Oftentimes, a cutting guide may be used to cut material that has already been sewn to another piece of material. In such cases, the cutting guide may be placed on top of the seam between the two pieces of material. Various cutting guides have been developed for such scenarios. For example, the Bloc_Loc cutting guide, which is the subject of U.S. Pat. No. 10,900,165, includes a recessed section on the bottom side of the cutting guide in which the seam can be positioned while cutting.

### BRIEF SUMMARY

The present disclosure is directed to a cutting guide having a protruding seam locking feature (or features) to facilitate the consistent cutting of a material with a desired shape or pattern. A seam locking feature protrudes from a bottom surface of the cutting guide to form a locking edge against which a seam can be aligned while the material is cut. A seam locking feature may be formed of a non-slip material to restrict movement of the cutting guide during cutting. A seam locking feature (or features) may have a variety of shapes or configurations to facilitate the cutting of material with a corresponding variety of shapes or patterns.

In some embodiments, a cutting guide may include a body having a top surface, a bottom surface and one or more sides extending therebetween, and a first protruding edge locking feature that protrudes from the bottom surface of the body. The first protruding edge locking feature may form a first locking edge against which a seam of material to be cut can be positioned to lock the seam in place relative to the one or more sides of the body.

In some embodiments, the first protruding edge locking feature may be separate from but secured to the body.

In some embodiments, the first protruding edge locking feature may be integral to the body.

In some embodiments, the first protruding edge locking feature may include a non-slip surface.

In some embodiments, the first protruding edge locking feature may be formed of a non-slip material.

In some embodiments, the cutting guide may include one or more support features that protrude from the bottom surface of the body.

In some embodiments, the one or more support features and the first protruding edge locking feature may protrude the same distance from the bottom surface of the body.

In some embodiments, the one or more supports features may include a non-slip surface.

In some embodiments, the body may include visual guides.

In some embodiments, the body may have a square shape and the first protruding edge locking feature may be configured to cause the first locking edge to extend linearly between opposing corners of the rectangular or square shape.

In some embodiments, the first protruding edge locking feature may be configured to cause the first locking edge to have a V shape.

In some embodiments, the first protruding edge locking feature may form a second locking edge against which a seam of material to be cut can be positioned to lock the seam in place relative to the one or more sides of the body.

In some embodiments, the cutting guide may include one or more additional protruding edge locking features that protrude from the bottom surface of the body. Each of the additional protruding edge locking features may include a first locking edge against which a seam of material to be cut can be positioned to lock the seam in place relative to the one or more sides of the body.

In some embodiments, the first protruding edge locking feature and each of the one or more additional protruding edge locking features may form a second locking edge against which a seam of material to be cut can be positioned to lock the seam in place relative to the one or more sides of the body.

In some embodiments, the first protruding edge locking feature and each of the one or more additional protruding edge locking features may be spaced apart but extend parallel to one another.

In some embodiments, the body may have a triangular shape and the first protruding edge locking feature and each of the one or more additional protruding edge locking features may extend parallel to a base of the triangular shape.

In some embodiments, the first protruding edge locking feature may be configured to cause the first locking edge to have a curved shape.

In some embodiments, the first protruding edge locking feature may be adhered to the bottom surface of the body.

In some embodiments, a cutting guide may include a body having a top surface, a bottom surface and four sides extending therebetween such that the body has a square or rectangular shape and a protruding edge locking feature that protrudes from the bottom surface of the body. The protruding edge locking feature may form a locking edge against which a seam of material to be cut can be positioned to lock the seam in place relative to the sides of the body. The protruding edge locking feature may be configured to cause the locking edge to extend linearly between opposing corners formed by the sides of the body.

In some embodiments, a cutting guide may include a body having a top surface, a bottom surface and one or more sides extending therebetween, and at least one protruding edge locking feature that protrudes from the bottom surface of the body. Each protruding edge locking feature may form multiple locking edges against which a seam of material to be cut can be positioned to lock the seam in place relative to the one or more sides of the body.

This summary is provided to introduce a selection of concepts in a simplified form that are further described below in the Detailed Description. This Summary is not intended to identify key features or essential features of the claimed subject matter.

### BRIEF DESCRIPTION OF THE DRAWINGS

Understanding that these drawings depict only typical embodiments of the invention and are not therefore to be considered limiting of its scope, the invention will be described and explained with additional specificity and detail through the use of the accompanying drawings in which:

FIG. 1A is a top view of an example cutting guide that is configured in accordance with one or more embodiments;

FIG. 1B is a bottom view of the example cutting guide of FIG. 1A;

FIGS. 1C and 1D are different side views of the example cutting guide of FIG. 1A;

FIG. 1E is a bottom perspective view of the example cutting guide of FIG. 1A;

FIG. 2 is a top view of another example cutting guide that is configured in accordance with one or more embodiments; and

FIGS. 3A-3E are each bottom views of additional example cutting guides that are configured in accordance with one or more embodiments.

### DETAILED DESCRIPTION

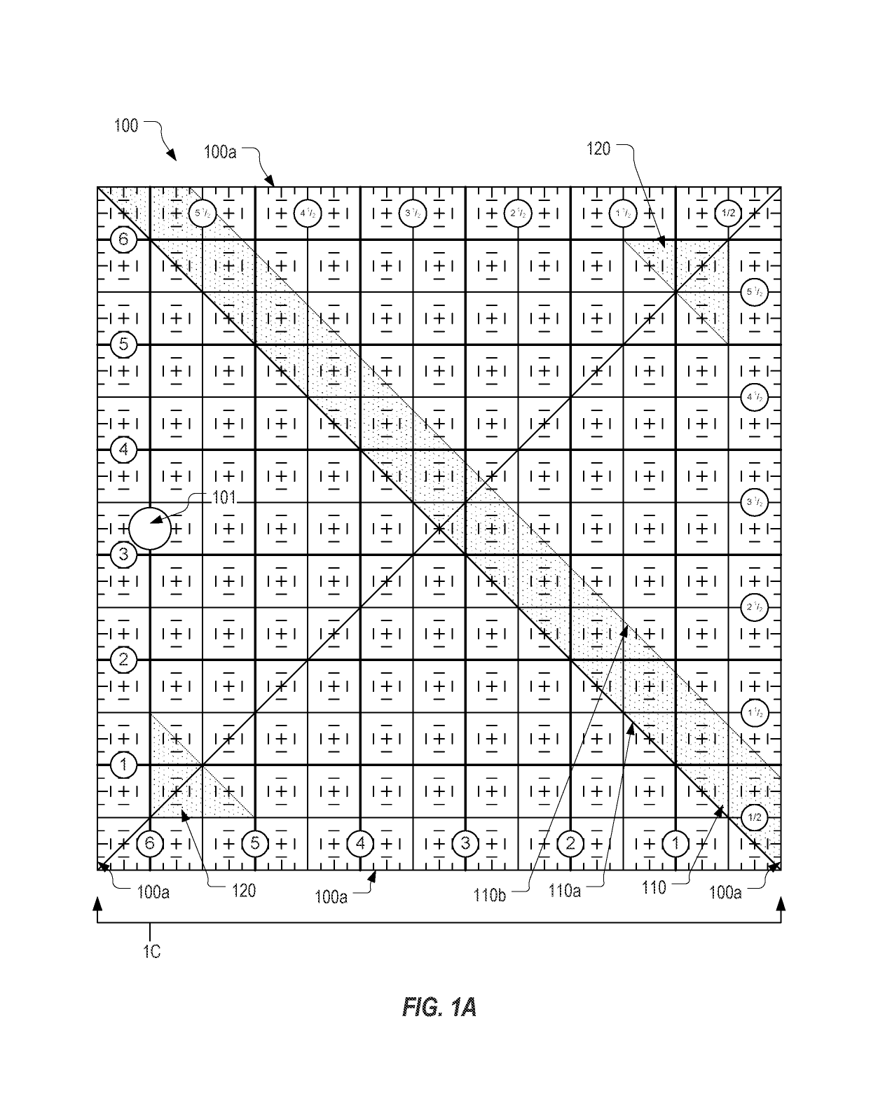

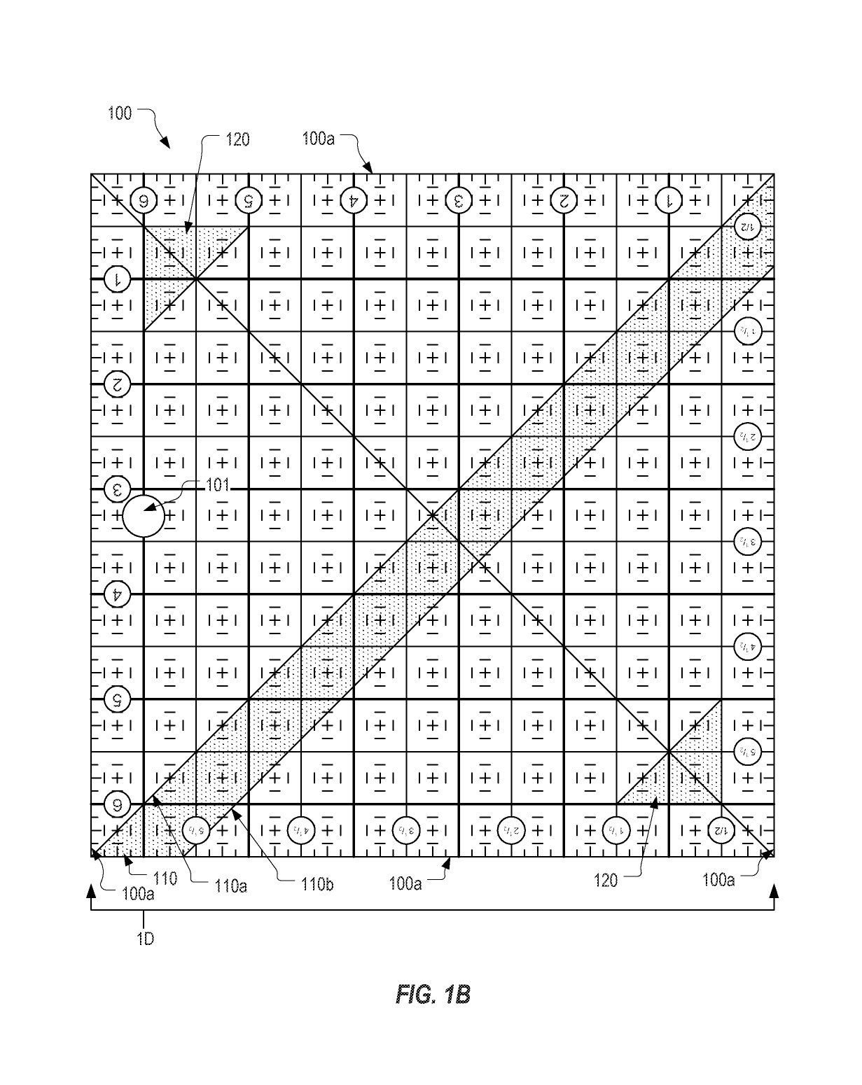

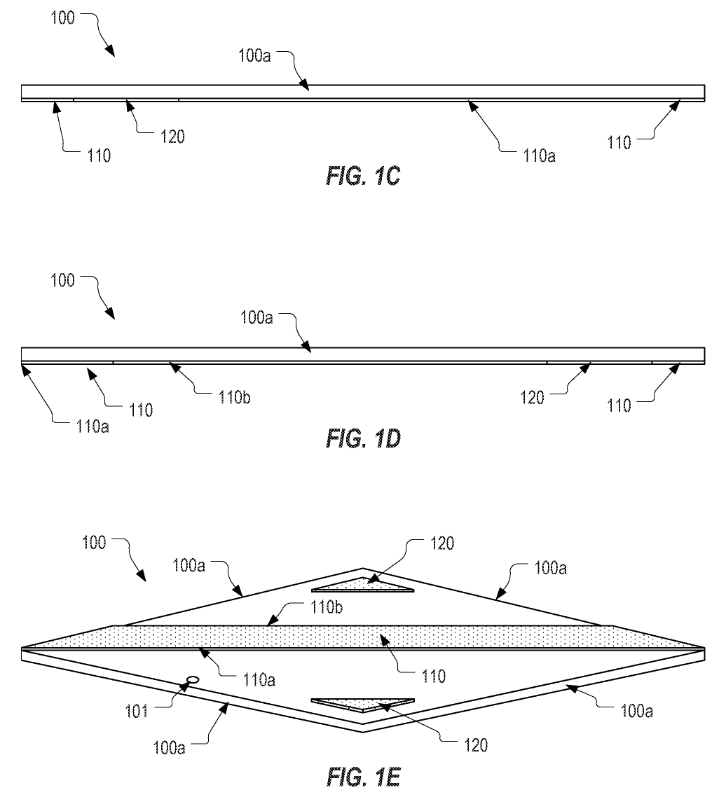

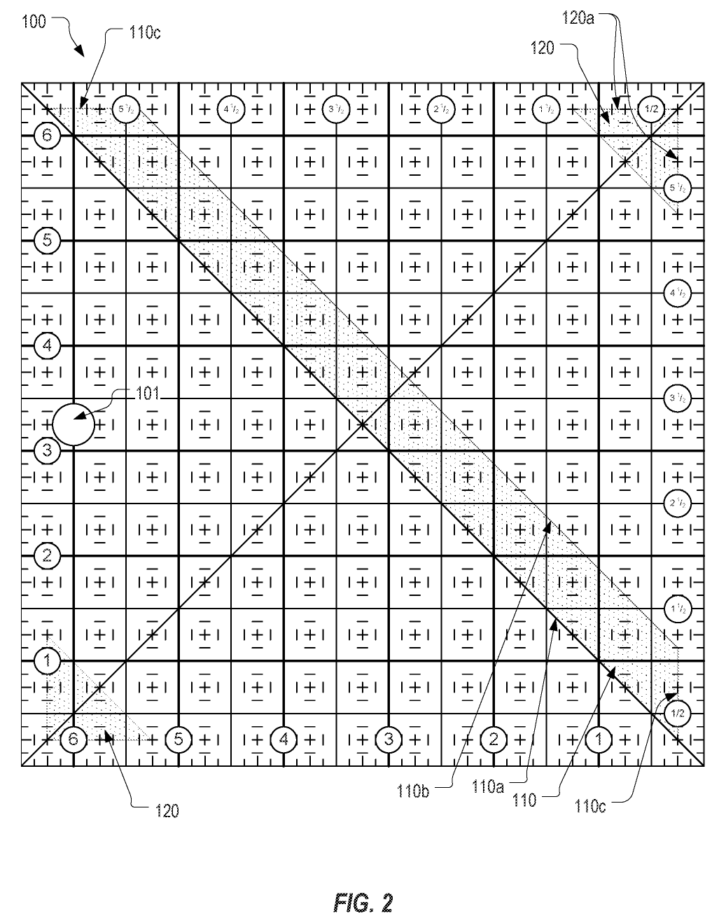

FIGS. 1A-1E are different views of an example cutting guide 100 that is configured in accordance with one or more embodiments of the present disclosure. Cutting guide 100 comprises a substantially flat body that may be formed of any suitable material and may preferably be transparent so that material to be cut remains visible when cutting guide 100 is placed on top of the material to be cut. In some embodiments, cutting guide 100 could be formed of acrylic.

Cutting guide 100 as shown in FIGS. 1A-1E has a square shape. However, in other embodiments, cutting guide 100 could have any other desired shape. Regardless of the shape, the sides 100a of cutting guide 100 can form an edge against which a cutting tool (e.g., a rotary cutter) can be moved to cut material that is positioned under cutting guide 100.

In some embodiments, such as is shown in FIGS. 1A and 1B, cutting guide 100 can include visual guides. For example, in these figures, cutting guide 100 includes grid lines and markings, some of which are numbered, marking each eighth of an inch, as well as diagonal guide lines extending between the corners. These visual guides could be formed in any suitable manner such as by printing and/or engraving on the top and/or bottom surfaces of cutting guide 100. In some embodiments, cutting guide 100 may include a hole 101. Hole 101 could be used to hang cutting guide 100 for storage, to facilitate picking up cutting guide 100, or for any other purpose.

As is best shown in FIG. 1E (which omits the visual guides for clarity), the bottom surface of cutting guide 100 includes a protruding seam locking feature 110 and support features 120. In some embodiments, protruding seam locking feature 110 could protrude approximately 1/16 of an inch from the bottom surface. However, the distance to which protruding seam locking feature 110 protrudes could be selected based on the characteristics of the material with which cutting guide 100 is intended to be used and/or based on other intended use cases.

Protruding seam locking feature 110 forms a locking edge 110a against which a seam can be aligned while material is cut. In other words, by placing cutting guide 100 on top of the material and forcing locking edge 110a against the seam, the seam can be locked in place relative to cutting guide 100. The material can then be cut in the desired shape by running a cutting tool along one or more sides 100a of cutting guide 100. In the depicted example, protruding seam locking feature 110 is shaped to enable cutting of the material in triangular shapes. In some embodiments, an opposing edge 110b of protruding seam locking feature 110 could also be used in this manner as a locking edge (e.g., to cut a smaller triangular shape).

Supports features 120 may also protrude from the bottom surface of cutting guide 100 to the same extent as protruding seam locking feature 110. Support features 120 can therefore ensure that cutting guide 100 remains flat (or coplanar) relative to the material to be cut even when cutting guide 100 is placed on top of a seam. In some embodiments, a support feature 120 may be included on any corner or section in which a protruding seam locking feature 110 is not located.

In some embodiments, protruding seam locking feature 110 and/or support features 120 may be separate from and adhered/secured to the bottom surface of cutting guide 100. In other embodiments, protruding seam locking feature 110 and/or support features 120 may be integral extensions of the material that forms cutting guide 100.

In some embodiments, protruding seam locking feature 110 and/or support features 120 may form a non-slip surface. For example, protruding seam locking feature 110 and/or support features 120 could be formed a non-slip material (e.g., a synthetic rubber or similar material that is adhered to the bottom surface of cutting guide 100). As another example, the bottom surfaces of protruding seam locking feature 110 and/or support features 120 could be textured to be non-slip or coated with a non-slip material.

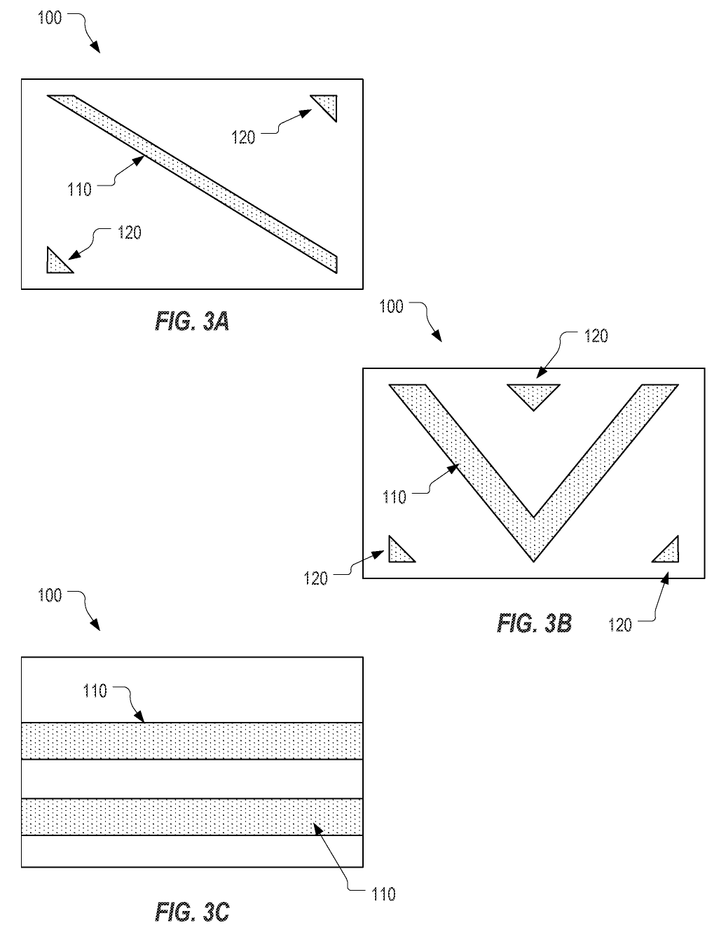

In the embodiments depicted in FIGS. 1A-1E, protruding seam locking feature 110 extends up to and aligns with sides 100a of cutting guide 100. However, in some embodiments, such as is shown in FIG. 1, protruding seam locking feature 110 may include edges 110c that are spaced from sides 100a of cutting guide 100 (e.g., at ¼ inch or at a distance representing the edge of the finished material). In some embodiments, a support feature 120 may include edge(s) 120a that are configured and positioned to align with edges 110c of protruding seam locking feature 110. For example, in FIG. 2, edges 110c and 120a extend parallel with but 1/4 inch from sides 100a of cutting guide 100. In such cases, edges 110c and 120a could function as locking edges similar to locking edge 110a.

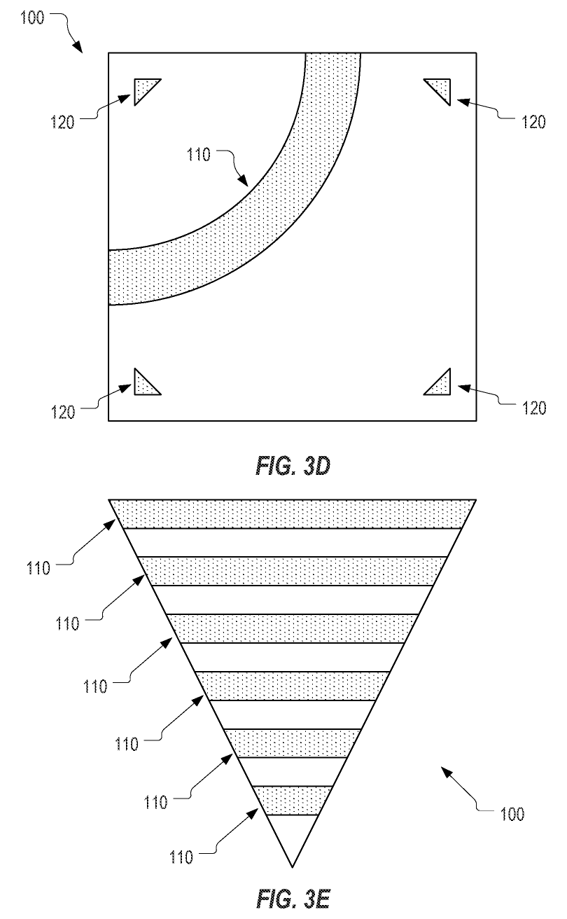

FIGS. 3A-3E each depict variations of cutting guide 100. In FIG. 3A, cutting guide 100 has a rectangular shape and protruding seam locking feature 110 extends diagonally in a similar manner as in FIG. 2. The orientation of protruding seam locking feature 110 could be inverted relative to what is shown in FIG. 3A to facilitate left-handed cutting (i.e., locking edge 110a could face upwardly and to the right rather than downwardly and to the left).

FIG. 3B represents an example where protruding seam locking feature 110 has a V-shape and three support features 120 are arranged in a V-shaped pattern that is inverted relative to protruding seam locking feature 110. This configuration can facilitate cutting flying geese patterns.

FIG. 3C represents an example where multiple protruding seam locking features 110 extend across a length of cutting guide 100 and are spaced apart. With this configuration, four locking edges 110a are provided, each of which facilitates cutting of rectangular shapes with different heights. This configuration can facilitate cutting log cabin patterns.

FIG. 3D represents an example where protruding seam locking feature 110 has an arched or curved shape. This configuration can facilitate cutting drunkard’s path patterns.

FIG. 3E represents an example where cutting guide 100 has a triangular shape and includes six protruding seam locking features 110. The locking edges 110a formed by each of these six protruding seam locking features 110 facilitate cutting triangular shapes of different sizes.

A protruding seam locking feature provides an advantage of accommodating different seam allowances (or the distance between the seam stitch line and the raw edges of the material). For example, a cutting guide that has a recessed feature for aligning the seam can only accommodate seam allowances up to the width of the recess. If the seam allowance exceeds the width of the recessed feature, the raw edges of the seam will extend beyond the recess thereby preventing the cutting guide from laying flat. In comparison, a cutting guide having a protruding seam locking feature in accordance with embodiments of the present disclosure will lay flat when any reasonable seam allowance is used.

What is claimed:

1. A cutting guide comprising:
a body having a top surface, a bottom surface and one or more sides extending therebetween;
a first protruding edge locking feature that protrudes from the bottom surface of the body, the first protruding edge locking feature forming a first locking edge against which a seam of material to be cut can be positioned to lock the seam in place relative to the one or more sides of the body.

2. The cutting guide of claim 1, wherein the first protruding edge locking feature is separate from but secured to the body.

3. The cutting guide of claim 1, wherein the first protruding edge locking feature is integral to the body.

4. The cutting guide of claim 1, wherein the first protruding edge locking feature comprises a non-slip surface.

5. The cutting guide of claim 1, wherein the first protruding edge locking feature is formed of a non-slip material.

6. The cutting guide of claim 1, further comprising:
one or more support features that protrude from the bottom surface of the body.

7. The cutting guide of claim 6, wherein the one or more support features and the first protruding edge locking feature protrude a same distance from the bottom surface of the body.

8. The cutting guide of claim 6, wherein the one or more supports features comprise a non-slip surface.

9. The cutting guide of claim 1, wherein the body includes visual guides.

10. The cutting guide of claim 1, wherein the body has a square shape and the first protruding edge locking feature is configured to cause the first locking edge to extend linearly between opposing corners of the rectangular or square shape.

11. The cutting guide of claim 1, wherein the first protruding edge locking feature is configured to cause the first locking edge to have a V shape.

12. The cutting guide of claim 1, wherein the first protruding edge locking feature forms a second locking edge against which a seam of material to be cut can be positioned to lock the seam in place relative to the one or more sides of the body.

13. The cutting guide of claim 1, further comprising:
one or more additional protruding edge locking features that protrude from the bottom surface of the body, each of the additional protruding edge locking features including a first locking edge against which a seam of material to be cut can be positioned to lock the seam in place relative to the one or more sides of the body.

14. The cutting guide of claim 13, wherein the first protruding edge locking feature and each of the one or more additional protruding edge locking features form a second locking edge against which a seam of material to be cut can be positioned to lock the seam in place relative to the one or more sides of the body.

15. The cutting guide of claim 14, wherein the first protruding edge locking feature and each of the one or more additional protruding edge locking features are spaced apart but extend parallel to one another.

16. The cutting guide of claim 15, wherein the body has a triangular shape and the first protruding edge locking feature and each of the one or more additional protruding edge locking features extend parallel to a base of the triangular shape.

17. The cutting guide of claim 1, wherein the first protruding edge locking feature is configured to cause the first locking edge to have a curved shape.

18. The cutting guide of claim 1, wherein the first protruding edge locking feature is adhered to the bottom surface of the body.

19. A cutting guide comprising:
a body having a top surface, a bottom surface and four sides extending therebetween such that the body has a square or rectangular shape;
a protruding edge locking feature that protrudes from the bottom surface of the body, the protruding edge locking feature forming a locking edge against which a seam of material to be cut can be positioned to lock the seam in place relative to the sides of the body, wherein the protruding edge locking feature is configured to cause the locking edge to extend linearly between opposing corners formed by the sides of the body.

20. A cutting guide comprising:
a body having a top surface, a bottom surface and one or more sides extending therebetween;
at least one protruding edge locking feature that protrudes from the bottom surface of the body, each protruding edge locking feature forming multiple locking edges against which a seam of material to be cut can be positioned to lock the seam in place relative to the one or more sides of the body.
